(19) United States
(12) Patent Application Publication
(10) Pub. No.: US 2011/0242263 A1
(43) Pub. Date: Oct. 6, 2011

(54) OPTICAL HEAD AND IMAGE FORMING APPARATUS

(75) Inventors: Kazutoshi Takahashi, Shizuoka-ken (JP); Koji Tanimoto, Shizuoka-ken (JP); Kenichi Komiya, Kanagawa-ken (JP); Daisuke Ishikawa, Shizuoka-ken (JP); Hiroyuki Ishikawa, Shizuoka-ken (JP)

(73) Assignees: Kabushiki Kaisha Toshiba, Tokyo (JP); Toshiba Tec Kabushiki Kaisha

(21) Appl. No.: 13/036,907

(22) Filed: Feb. 28, 2011

Related U.S. Application Data
(60) Provisional application No. 61/320,278, filed on Apr. 1, 2010.

(51) Int. Cl. B41J 27/00

(52) U.S. Cl. 347/258

(57) ABSTRACT

An optical head includes a light-emitting board that emits light, an attachment base that has a surface to which the light-emitting board is attached by an adhesive and a groove which is provided in the surface and extends to a portion below the light-emitting board, and a lens to condense the light emitted from the light-emitting board.

### CROSS-REFERENCE TO RELATED APPLICATION(S)

This application is based upon and claims the benefit of priority from U.S. provisional application 61/320,278, filed on Apr. 1, 2010; the entire contents of which are incorporated herein by reference.

### FIELD

Embodiments described herein relate generally to an optical head for emitting light and an image forming apparatus using the optical head.

### BACKGROUND

An optical head emits light used for exposing a photoreceptor. The optical head includes a light-emitting board and an attachment base, and the light-emitting board is attached to the attachment base by an adhesive.

When the optical head is recycled, the light-emitting board and the attachment base are sometimes disassembled. Since the light-emitting board is fixed to the attachment base by the adhesive, it is difficult to disassemble the light-emitting board and the attachment base.

### DESCRIPTION OF THE DRAWINGS

FIG. 1 is a view showing an inner structure of an image forming apparatus.

FIG. 2 is a sectional view of an optical printer head of a first embodiment.

FIG. 3 is an outer appearance view of the optical printer head of the first embodiment.

FIG. 4 is a top view of a light-emitting board and an attachment base.

FIG. 5 is a sectional view before the light-emitting board and the attachment base are disassembled.

FIG. 6 is a sectional view after the light-emitting board and the attachment base are disassembled.

FIG. 7 is a top view of an attachment base of a modified example of the first embodiment.

FIG. 8 is an outer appearance view of a disassembling tool of the first embodiment.

FIG. 9 is an outer appearance view of a light-emitting board and an attachment base of a second embodiment.

FIG. 10 is a sectional view of the light-emitting board and the attachment base of the second embodiment.

FIG. 11 is a top view of an attachment base of a modified example of the second embodiment.

### DETAILED DESCRIPTION

According to an embodiment, an optical head includes a light-emitting board that emits light, an attachment base that has a surface to which the light-emitting board is attached by an adhesive and a groove which is provided in the surface and extends to a portion below the light-emitting board, and a lens to condense the light emitted from the light-emitting board.

### First Embodiment

A first embodiment will be described with reference to the drawings.

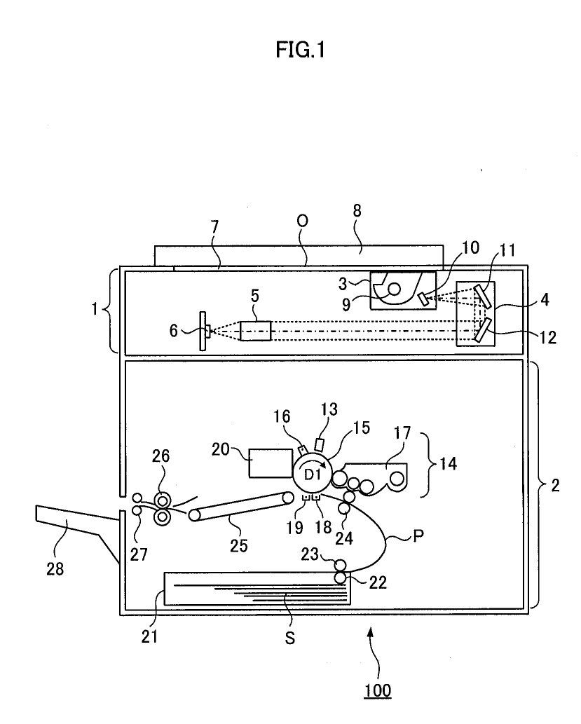

FIG. 1 is a view showing an inner structure of an image forming apparatus. The image forming apparatus 100 includes a scanner part 1 and a printer part 2. The scanner part 1 reads an image of a document O. The printer part 2 forms the image on a sheet.

The document O is placed on a document table glass 7. The read surface of the document O is directed downward and contacts the document table glass 7. A cover 8 rotates between a position where the document table glass 7 is closed and a position where the document table glass 7 is opened. When the cover 8 closes the document table glass 7, the cover 8 presses the document O to the document table glass 7.

A light source 9 emits light to the document O. The light of the light source 9 passes through the document table glass 7 and reaches the document O. The reflected light from the document O is reflected by mirrors 10, 11 and 12 in this order, and is guided to a condensing lens 5. The condensing lens 5 condenses the light from the mirror 12, and forms an image on a light receiving surface of a photoelectric conversion element 6. The photoelectric conversion element 6 receives the light from the condensing lens 5 and converts it into an electric signal (analog signal).

The output signal of the photoelectric conversion element 6 is subjected to a specified signal processing, and is outputted to an optical printer head 13. The specified signal processing is a processing for generating image data (digital data) of the document O. As the photoelectric conversion element 6, for example, a CCD sensor or a CMOS sensor can be used.

A first carriage 3 supports the light source 9 and the mirror 10, and moves along the document table glass 7. A second carriage 4 supports the mirrors 11 and 12, and moves along the document table glass 7. The first carriage 3 and the second carriage 4 independently move, and keep the light path length from the document O to the photoelectric conversion element 6 constant.

When the image of the document O is read, the first carriage 3 and the second carriage 4 move in one direction. While the first carriage 3 and the second carriage 4 move in the one direction, the light source 9 emits the light to the document O. The reflected light from the document O forms an image on the photoelectric conversion element 6 by the mirrors 10 to 12 and the condensing lens 5. The image of the document O is sequentially read one line by one line in the movement direction of the first carriage 3 and the second carriage 4.

The printer part 2 includes an image forming part 14. The image forming part 14 forms an image on a sheet S conveyed from a paper feed cassette 21. The plural sheets S received in the paper feed cassette 21 are separated one by one by a conveyance roller 22 and a separation roller 23, and are sent to the image forming part 14. The sheet S reaches a register roller 24 while moving along a conveyance path P. The register roller 24 moves the sheet S to a transfer position of the image forming part 14 at a specified timing.

A conveyance mechanism 25 moves the sheet S on which the image is formed by the image forming part 14 to a fixing unit 26. The fixing unit 26 heats the sheet S and fixes the image to the sheet S. A paper discharge roller 27 moves the sheet S on which the image is fixed to a paper discharge tray 28.

Next, an operation of the image forming part 14 will be described.

The optical printer head 13, a charging unit 16, a developing unit 17, a transfer charger 18, a peeling charger 19 and a cleaner 20 are disposed around a photoconductive drum 15. The photoconductive drum 15 rotates in a direction of an arrow D1.

The charging unit 16 charges the surface of the photoconductive drum 15. The optical printer head 13 exposes the charged photoconductive drum 15. The optical printer head 13 causes plural light beams to reach an exposure position of the photoconductive drum 15.

When the light beams from the optical printer head 13 reach the photoconductive drum 15, the potential at the exposure portion is lowered, and an electrostatic latent image is formed. The developing unit 17 supplies a developer to the surface of the photoconductive drum 15 and forms a developer image on the surface of the photoconductive drum 15.

When the developer image reaches the transfer position by the rotation of the photoconductive drum 15, the transfer charger 18 transfers the developer image on the photoconductive drum 15 to the sheet S. The peeling charger 19 peels the sheet S from the photoconductive drum 15. The cleaner 20 removes a developer remaining on the surface of the photoconductive drum 15.

While the photoconductive drum 15 rotates, the formation of the electrostatic latent image, the formation of the developer image, the transfer of the developer image and the cleaning of the remaining developer image can be continuously performed. That is, the operation of forming the image on the sheet S can be continuously performed.

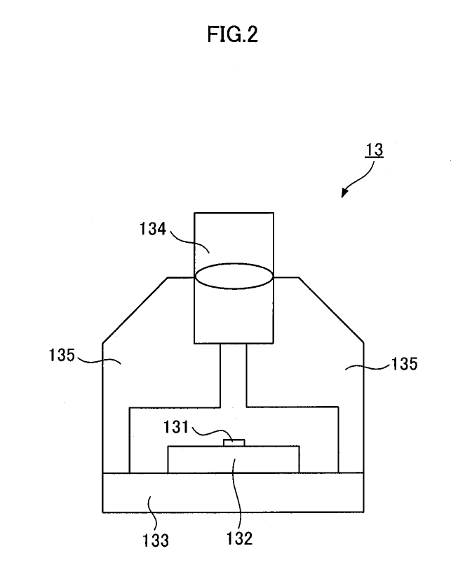

A structure of the optical printer head 13 will be specifically described with reference to FIG. 2. FIG. 2 is a sectional view of the optical printer head 13.

A light-emitting board 132 extends in a direction perpendicular to the paper surface of FIG. 2, and has plural light emitting points 131. The plural light emitting points 131 are arranged side by side in the longitudinal direction of the light-emitting board 132. For example, when the resolution of an image formed by the image forming part 14 is 1200 dpi, 1200 light emitting points 131 per inch are provided.

As the light emitting points 131, for example, organic electroluminescence elements or LEDs (Light Emitting Diode) can be used. The light-emitting board 132 can be formed of, for example, glass.

An attachment base 133 supports the light-emitting board 132, and is formed of, for example, resin or metal. When the attachment base 133 is formed of metal, it becomes easy to release the heat generated in the light-emitting board 132 at the time of light emission of the light emitting points 131 to the attachment base 133.

The lights emitted from the light emitting points 131 are incident on a SELFOC lens array 134. The SELFOC lens array 134 includes plural SELFOC lenses, and the plural SELFOC lenses are arranged side by side in the longitudinal direction of the light light-emitting board 132. The light emitted from each of the light emitting points 131 is incident on the corresponding SELFOC lens.

The SELFOC lens array 134 condenses plural lights (diffused lights) from the plural light emitting points 131 and causes the lights to reach the exposure position of the photoconductive drum 15. A spot light with a desired resolution is formed at the exposure position. A lens holder 135 holds the SELFOC lens array 134.

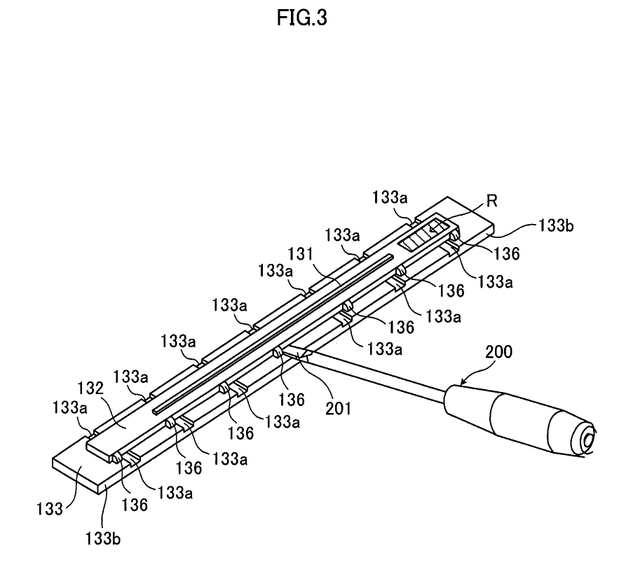

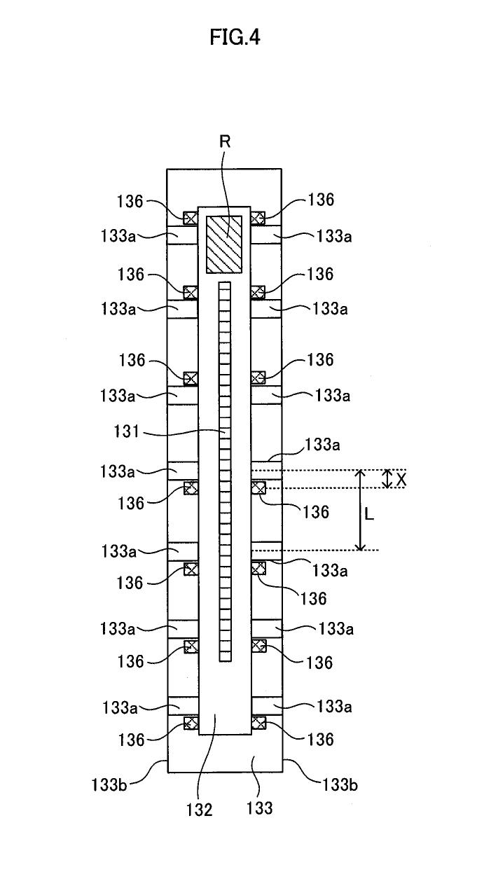

FIG. 3 and FIG. 4 are outer appearance views of the light-emitting board 132 and the attachment base 133.

A wiring line is connected to an area R of the light-emitting board 132, and the wiring line sends a drive signal to the light emitting points 131.

The attachment base 133 includes plural grooves 133a. Each of the grooves 133a extends in a direction (right and left direction of FIG. 4) perpendicular to the longitudinal direction of the attachment base 133, and extends to both side surfaces 133b of the attachment base 133. The plural grooves 133a are arranged at regular intervals in the longitudinal direction (up and down direction of FIG. 4) of the attachment base 133. That is, each of the grooves 133a extends to a portion below the light-emitting board 132 and is further formed to reach the opposite side surface of the attachment base 133.

The grooves 133a may be inclined relative to the longitudinal direction of the attachment base 13. The plural grooves 133a may be arranged at different intervals in the longitudinal direction of the attachment base 133.

An adhesive 136 is used to fix the light-emitting board 132 to the attachment base 133, and is applied to a position adjacent to the groove 133a. The adhesive 136 is applied along the groove 133a. The adhesive 136 is adhered to the upper surface of the attachment base 133 and the lower surface of the light-emitting board 132. In a portion where the adhesive 136 is not applied, the light-emitting board 132 and the attachment base 133 merely contact each other.

The adhesive 136 has only to adhere the light-emitting board 132 to the attachment base 133, and the material of the adhesive 136 can be selected based on the material of the light-emitting board 132 and the attachment base 133.

The groove 133a of the attachment base 133 can be used to press the light-emitting board 132 to the attachment base 133. The light-emitting board 132 is deformed to the inside of the groove 133a, so that the light-emitting board 132 can be pressed to the attachment base 133. The light-emitting board 132 is pressed to the attachment base 133, so that it becomes easy to adhere the light-emitting board 132 and the attachment base 133 to each other.

In this embodiment, the adhesive 136 is applied to only one side of each of the grooves 133a. The adhesive 136 can also be applied to both sides of each of the grooves 133a.

The position where the adhesive 136 is applied can be determined based on following expression (1).

X<L/2 (1)

As shown in FIG. 4, L denotes an interval between two adjacent grooves 133a in the longitudinal direction of the light-emitting board 132. Specifically, L denotes a distance between the center of one groove 133a and the center of the other groove 133a. The center of the groove 133a is the center of the groove 133a in the longitudinal direction of the light-emitting board 132.

L denotes an interval between the application position of the adhesive 136 and the groove 133a. Specifically, L denotes a distance between the center of the groove 133a and the center of the application region of the adhesive 136. The center of the application area of the adhesive 136 is the center of the application area in the longitudinal direction of the light-emitting board 132.

The groove 133a is used when the light-emitting board 132 and the attachment base 133 are disassembled. For example, as shown in FIG. 3, a tip 201 of a minus driver 200 is inserted in the groove 133a, so that the light-emitting board 132 and the attachment base 133 can be separated.

When the adhesive 136 is separate from the groove 133a, it becomes difficult to separate the light-emitting board 132 from the attachment base 133 by using the groove 133a. When the light-emitting board 132 and the attachment base 133 are separated from each other, a part of the light-emitting board 132 corresponding to the groove 133a is deformed. When the adhesive 136 is separate from the groove 133a, even if the light-emitting board 132 is deformed, a part of the light-emitting board 132 to which the adhesive 136 is applied becomes hard to deform.

The procedure when the light-emitting board 132 and the attachment base 133 are separated from each other will be described.

FIG. 5 is a side view of the light-emitting board 132 and the attachment base 133, and is a view showing a peripheral structure of one groove 133a. As shown in FIG. 5, a width W1 of the groove 133a is larger than a width W2 of the tip 201 of the minus driver 200. The width W1 is the length of the groove 133a in the longitudinal direction of the attachment base 133. The width W2 is the length of a long side portion of the tip 201.

A depth T1 of the groove 133a is larger than a thickness T2 of the tip 201 of the minus driver 200. The dimensions W1 and T1 of the groove 133a are set so that the tip 201 of the minus driver 200 can be inserted in the groove 133a. FIG. 5 shows a state where the tip 201 of the minus driver 200 is inserted in the groove 133a.

After the tip 201 of the minus driver 200 is inserted in the groove 133a, when the tip 201 is rotated in a direction of an arrow D2, one end of the tip 201 contacts the light-emitting board 132, and the other end of the tip 201 contacts the bottom of the groove 133a.

Since the width W2 of the tip 201 is larger than the depth T1 of the groove 133a, when the tip 201 is rotated in the direction of the arrow D2, the force in the direction of separating the light-emitting board 132 from the attachment base 133 can be generated. When the force of separating the light-emitting board 132 from the attachment base 133 becomes larger than the adhesive force of the adhesive 136, the light-emitting board 132 and the attachment base 133 can be separated from each other.

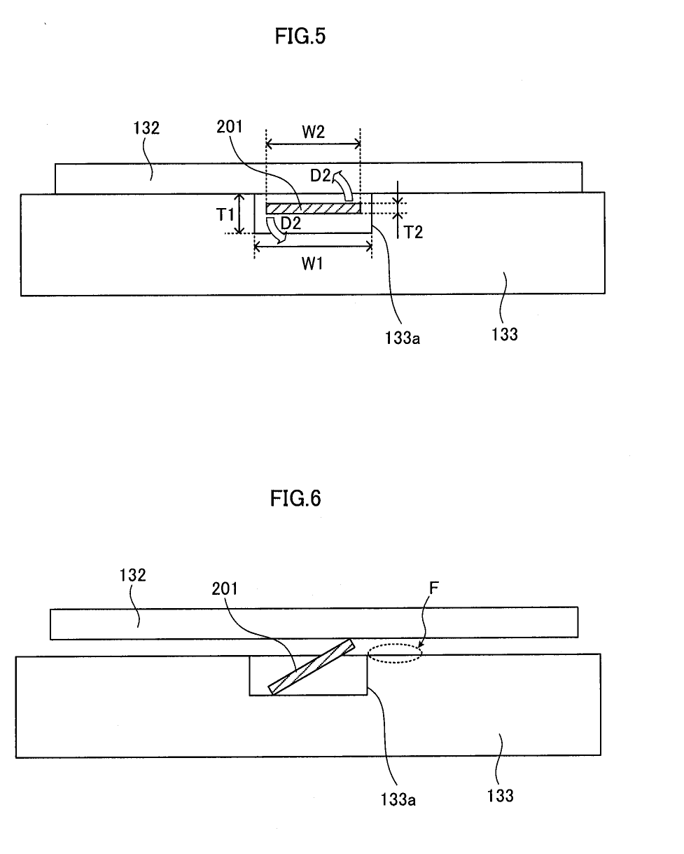

In FIG. 6, the force when the tip 201 is rotated in the direction of the arrow D2 is liable to be exerted on an area F. When the adhesive 136 is applied to the area F, the force when the tip 201 is rotated is liable to be exerted on the adhesive 136, and the light-emitting board 132 and the attachment base 133 can be easily separated from each other.

With the width W1 and the depth T1 of the groove 133a are set with reference to the minus driver 200 of the smallest size, the minus driver 200 of any size can be used. In this embodiment, although the minus driver 200 is used, anything may be used as long as it can be inserted in the groove 133a.

The operation method of the minus driver 200 to separate the light-emitting board 132 from the attachment base 133 is arbitrary. For example, the frontmost edge of the minus driver 200 is brought into contact with the bottom of the groove 133a, and the minus driver 200 can be rotated around the contact point. When the minus driver 200 is rotated, a part of the tip 201 contacts the light-emitting board 132, and the light-emitting board 132 can be separated from the attachment base 133.

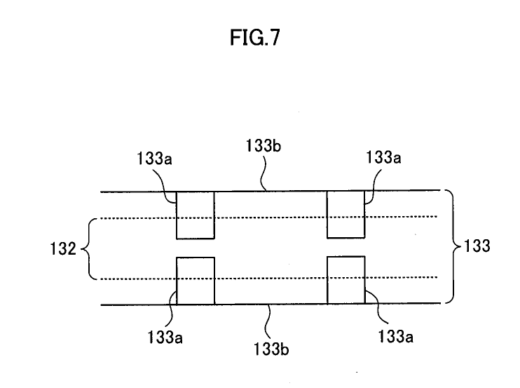

In this embodiment, although the groove 133a extends from the one side surface 133b of the attachment base 133 to the other side surface 133b, as shown in FIG. 7, the groove 133a may be formed only in a partial area of the attachment base 133. FIG. 7 shows a structure of a modified example of this embodiment and is a top view of the light-emitting board 132 and the attachment base 133. In the structure shown in FIG. 7, it is necessary that a part of the groove 133a is positioned below the light-emitting board 132. That is, the groove 133a extends to a portion below the light-emitting board 132.

Also in the structure shown in FIG. 7, when the tip 201 of the minus driver 200 is inserted in the groove 133a, the force to separate the light-emitting board 132 from the attachment base 133 can be generated.

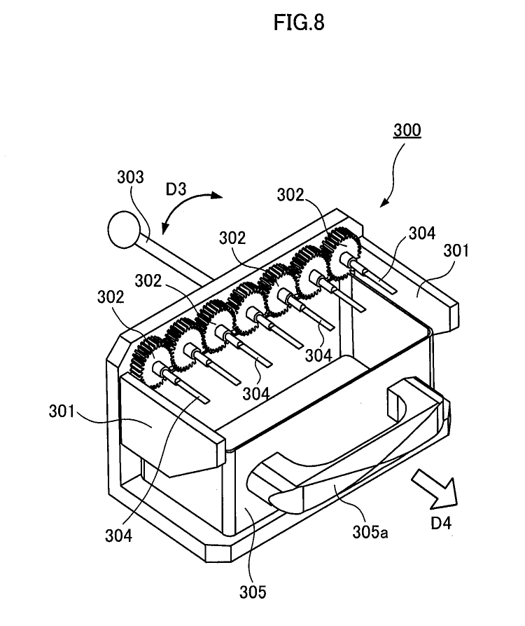

FIG. 8 shows a disassembling tool for disassembling the light-emitting board 132 and the attachment base 133.

The attachment base 133 to which the light-emitting board 132 is adhered is placed on a stand 301 of the disassembling tool 300. The disassembling tool 300 includes plural gears 302 arranged in one direction, and two adjacent gears 302 are engaged with each other. The number of the gears 302 is equal to the number of the grooves 133a formed in the attachment base 133.

A lever 303 is coupled to a specific gear 302 of the plural gears 302. When the lever 303 rotates in a direction of an arrow D3, the specific gear 302 coupled to the lever 303 is rotated. When the specific gear 302 is rotated, the gear 302 engaged with the specific gear 302 is also rotated. The operation force of the lever 303 is transmitted to all the gears 302, and all the gears 302 are rotated.

A separator 304 is provided on a rotation axis of each of the gears 302. The separator 304 is a member corresponding to the minus driver 200 explained in FIG. 3.

A dust shoot 305 is disposed below the separator 304. The dust shoot 305 receives the light-emitting board 132 separated from the attachment base 133. The dust shoot 305 includes a grip 305a, and the dust shoot 305 can be removed from the disassembling tool 300 by pulling the grip 305a in a direction of an arrow D4.

The procedure when the light-emitting board 132 and the attachment base 133 are disassembled by using the disassembling tool 300 will be described.

The attachment base 133 to which the light-emitting board 132 is adhered is placed on the stand 301. When the attachment base 133 is placed on the stand 301, the light-emitting board 132 is directed downward.

When the attachment base 133 is slid along the stand 301, each of the separators 304 enters the corresponding groove 133a of the attachment base 133. After the separator 304 enters the groove 133a, when the lever 303 is rotated in the direction of the arrow D3, the gear 302 and the separator 304 rotate in accordance with the rotation of the lever 303.

When the separator 304 rotates, similarly to the case explained in FIG. 5 and FIG. 6, a force in a direction of separating the light-emitting board 132 and the attachment base 133 from each other can be generated. When the light-emitting board 132 and the attachment base 133 are separated from each other, the light-emitting board 132 drops by its own weight, and is received in the dust shoot 305. The attachment base 133 remains placed on the stand 301.

### Second Embodiment

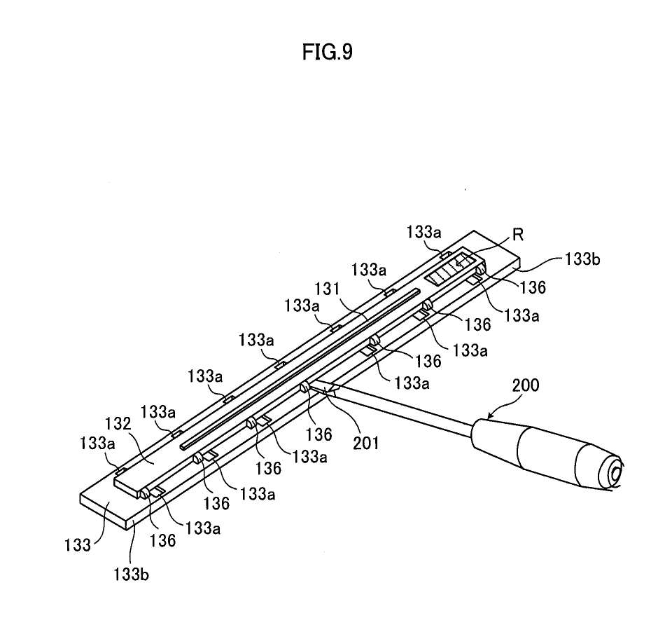

An optical printer head of a second embodiment will be described with reference to FIG. 9.

In the first embodiment, although the groove 133a extends to both the side surfaces 133b of the attachment base 133, in this embodiment, as shown in FIG. 9, a groove 133a does not extend to both side surfaces 133b of an attachment base 133.

Next, the procedure when a light-emitting board 132 and the attachment base 133 are separated from each other will be described.

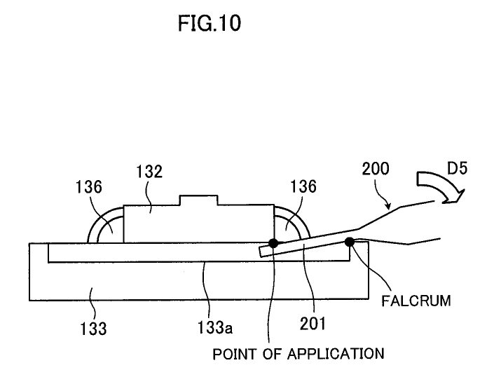

As shown in FIG. 9 and FIG. 10, a tip 201 of a minus driver 200 is inserted in the groove 133a. As shown in FIG. 10, an end of the tip 201 contacts a bottom of the groove 133a, and a base end side of the tip 201 contacts an edge of the groove 133a.

When the minus driver 200 rotates in a direction of an arrow D5 of FIG. 10, a part of the tip 201 in contact with the edge of the groove 133a becomes a fulcrum, and the end of the tip 201 becomes a point of application, and a force in a direction of separating the light-emitting board 132 from the attachment base 133 can be generated.

The tip 201 of the minus driver 200 is inserted in the groove 133a, so that the light-emitting board 132 and the attachment base 133 can be separated from each other by the principle of lever.

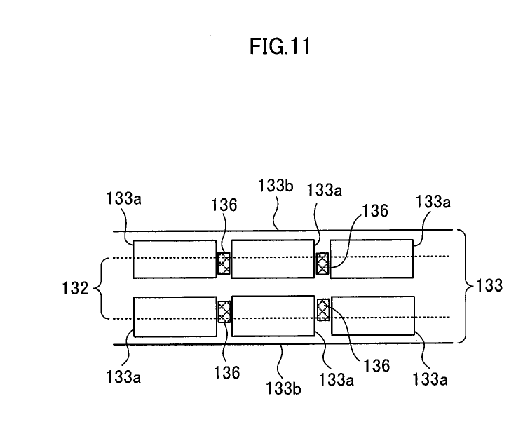

In this embodiment, although the width of the groove 133a is set according to the size of the minus driver 200, as shown in FIG. 11, the width of the groove 133a can be further widened. The width of the groove 133a is the length of the groove 133a in the longitudinal direction of the attachment base 133.

In the structure shown in FIG. 11, plural grooves 133a are arranged side by side in the longitudinal direction (right and left direction of FIG. 11) of the attachment base 133, and the two grooves 133a are arranged side by side in a direction (up and down direction of FIG. 11) perpendicular to the longitudinal direction of the attachment base 133.

In this embodiment (FIG. 9), the interval between the two adjacent grooves 133a in the longitudinal direction of the attachment base 133 is wider than the width of the groove 133a. On the other hand, in the structure shown in FIG. 11, the interval between the two adjacent grooves 133a in the longitudinal direction of the attachment base 133 is narrower than the width of the groove 133a.

In this embodiment, although the groove 133a is separate from both the side surfaces 133b of the attachment base 133, the groove 133a may be separate from only one of both the side surfaces 133b. In other words, the groove 133a extends to one side surface 133b of the attachment base 133 and is separate from the other side surface 133b.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An optical head comprising:
a light-emitting board that emits light;
an attachment base that has a surface to which the light-emitting board is attached by an adhesive and a groove which is provided in the surface and extends to a portion below the light-emitting board; and
a lens to condense the light emitted from the light-emitting board.

2. The head of claim 1, wherein
a width of the groove is larger than a width of a tool to separate the light-emitting board, and
a depth of the groove is smaller than the width of the tool and is larger than a thickness of the tool.

3. The head of claim 1, wherein the adhesive is applied to a position adjacent to the groove.

4. The head of claim 3, wherein the adhesive is applied to one side of the groove.

5. The head of claim 1, wherein the light-emitting board and the attachment base extend in one direction.

6. The head of claim 5, wherein the groove extends in a direction perpendicular to a longitudinal direction of the attachment base.

7. The head of claim 1, wherein the light-emitting board includes a plurality of light emitting points.

8. The head of claim 7, wherein the plurality of light emitting points are arranged in one direction.

9. The head of claim 1, wherein the attachment base includes a plurality of the grooves.

10. The head of claim 9, wherein
the attachment base extends in one direction, and
the plurality of the grooves are arranged side by side in a longitudinal direction of the attachment base.

11. The head of claim 1, wherein the groove extends from one side surface of the attachment base to the other side surface.

12. The head of claim 1, wherein the groove is separate from at least one side surface of both side surfaces of the attachment base.

13. An image forming apparatus, comprising:
a photoreceptor;
a light-emitting board configured to emit light to the photoreceptor charged by a charging unit to charge a surface of the photoreceptor;
an attachment base that has a surface to which the light-emitting board is attached by an adhesive and a groove which is provided in the surface and extends to a portion below the light-emitting board;
a lens to condense the light emitted from the light-emitting board to the photoreceptor, and
a developing unit to supply a developer to the photoreceptor.

14. The apparatus of claim 13, wherein
a width of the groove is larger than a width of a tool to separate the light-emitting board, and
a depth of the groove is smaller than the width of the tool and is larger than a thickness of the tool.

15. The apparatus of claim 13, wherein the adhesive is applied to a position adjacent to the groove.

16. The head of claim 13, wherein
the light-emitting board and the attachment base extends in one direction, and
the groove extends in a direction perpendicular to a longitudinal direction of the attachment base.

17. The apparatus of claim 13, wherein the groove is separate from at least one side surface of both side surfaces of the attachment base.
